(19) United States
(12) Patent Application Publication
(10) Pub. No.: US 2025/0278354 A1
(43) Pub. Date: Sep. 4, 2025

(54) SYSTEMS AND METHODS FOR DETERMINING EFFECTIVENESS OF DATA LOSS PREVENTION TESTING

(71) Applicant: Capital One Services, LLC, McLean, VA (US)

(72) Inventors: David Wolkiser, New York, NY (US); Alexander Kent, McLean, VA (US); Kyle Flaherty, Richmond, VA (US)

(21) Appl. No.: 18/591,019

(22) Filed: Feb. 29, 2024

(51) Int. Cl. G06F 11/36; G06F 11/07

(52) U.S. Cl. CPC G06F 11/3688; G06F 11/0766

(57) ABSTRACT

Disclosed embodiments may include a method for determining effectiveness of data loss prevention testing. The system may include one or more processors, and memory in communication with the one or more processors and storing instructions that, when executed by the one or more processors, are configured to cause the system to receive data loss prevention (DLP) sample test data, run a plurality of DLP tests utilizing the DLP sample test data, and identify, for each data element type of a plurality of data element types, an inherent risk measure associated with the data type element. Then, after receiving DLP test results, determine a plurality of data element type-channel effectiveness measures and a plurality of residual risk measures, and output the plurality of residual risk measures for display via a graphical user interface of a user device.

### CROSS-REFERENCE TO RELATED APPLICATIONS

This application relates to U.S. patent application Ser. No. 18/591,190, filed Feb. 29, 2024, bearing docket number COF0375 (029424.4118), listing Kyle Flaherty, Humza Jaffri, John Fox, Scott Jason Schenkein, Katherine Hall, and David DaSilva as inventors, and entitled “SYSTEMS AND METHODS FOR AUTOMATED GENERATIVE DATA LOSS PREVENTION TESTING,” the entire contents of which are hereby fully incorporated by reference as if fully set forth herein.

### FIELD

The disclosed technology relates to systems and methods for determining effectiveness of data loss prevention testing. Specifically, this disclosed technology relates to using machine learning models and graphical user interfaces to determine an effectiveness of data loss prevention programs.

### BACKGROUND

The protection of data from exfiltration is becoming increasingly difficult to stop and detect. To be able to properly select among the available data exfiltration prevention software programs, the current exfiltration prevention software programs need to be tested. However, traditional testing of data exfiltration prevention software programs relies on ineffective testing data sets and unreliable testing methods that are highly inefficient, time consuming, and costly. For example, if testing data involved a creation of a random social security number in a format such as ‘234-62-1345,’ the testing methods of exfiltration prevention software programs would be trained to test the exfiltration of social security numbers based on two dashes and the nine digits. However, the same testing program might fail to detect an exfiltration of a social security number sent in an email written in an alternative format such as ‘social: 134575234’ due to the lack of dashes and spacing.

Accordingly, there is a need for improved systems and methods for automated, dynamic, and generative data loss prevention testing. Embodiments of the present disclosure are directed to this and other considerations.

### SUMMARY

Disclosed embodiments may include a system for determining effectiveness of data loss prevention testing. The system may include one or more processors, and memory in communication with the one or more processors and storing instructions that, when executed by the one or more processors, are configured to cause the system to determine the effectiveness of data loss prevention by

Disclosed embodiments may include a system for determining effectiveness of data loss prevention testing. The system may include one or more processors, and memory in communication with the one or more processors and storing instructions that, when executed by the one or more processors, are configured to cause the system to determine the effectiveness of data loss prevention by receiving data loss prevention (DLP) sample test data. In some embodiments, the DLP sample test data can include a plurality of data element types. In some embodiments, the memory may be further configured to cause the system to run a plurality of DLP tests utilizing the DLP sample test data by utilizing one or more test channels. In some embodiments, the memory may be further configured to cause the system to identify, for each data element type of the plurality of data element types, an inherent risk measure associated with the data type element, receive DLP test results, and determine, based on the DLP test results, a plurality of data element type-channel effectiveness measures. In some embodiments, each of the plurality of data element type-channel effectiveness measures can include an enforcement effectiveness measure and a detection effectiveness measure associated with one of the plurality of data element types tested on one of the one or more test channels. In some embodiments, the memory may be further configured to cause the system to determine, based on the plurality of data element type-channel effectiveness measures and the inherent risk measure associated with each data element type of the plurality of data element types, a plurality of residual risk measures. Each of the plurality of residual risk measures can represent a residual risk associated with one of the plurality of data element types tested on one of the one or more test channels. In some embodiments, the memory may be further configured to cause the system to output the plurality of residual risk measures for display via a graphical user interface (GUI) of a user device.

Disclosed embodiments may include a system for determining effectiveness of data loss prevention testing. The system may include one or more processors, and memory in communication with the one or more processors and storing instructions that, when executed by the one or more processors, are configured to cause the system to determine the effectiveness of data loss prevention by identifying, for each data element type of a plurality of data element types, an inherent risk measure associated with the data type element, receiving DLP test results, and determining, based on the DLP test results, a plurality of data element type-channel effectiveness measures. In some embodiments, each of the plurality of data element type-channel effectiveness measures can include an enforcement effectiveness measure and a detection effectiveness measure associated with one of the plurality of data element types tested on one of one or more test channels. In some embodiments, the memory may be further configured to cause the system to determine, based on the plurality of data element type-channel effectiveness measures and the inherent risk measure associated with each data element type of the plurality of data element types, a plurality of residual risk measures. Each of the plurality of residual risk measures can represent a residual risk associated with one of the plurality of data element types tested on one of the one or more test channels. In some embodiments, the memory may be further configured to cause the system to output the plurality of residual risk measures for display via a GUI of a user device.

Disclosed embodiments may include a system for determining effectiveness of data loss prevention testing. The system may include one or more processors, and memory in communication with the one or more processors and storing instructions that, when executed by the one or more processors, are configured to cause the system to determine the effectiveness of data loss prevention by receiving an indication of a selected data element type and a selected test channel, causing one or more DLP tests to be run using the selected test channel and using test data comprising data of the selected data element type, and receiving DLP test results associated with the one or more DLP tests. In some embodiments, the memory may be further configured to cause the system to determine, based on the DLP test results, an effectiveness measure. The effectiveness measure can include an enforcement effectiveness measure and a detection effectiveness measure associated with the selected data element type tested on the selected test channel. In some embodiments, the memory may be further configured to cause the system to determine, based on the effectiveness measure and an inherent risk measure associated with the selected data element type, a residual risk measure, and output the residual risk measure for display by a GUI of a user device.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for determining effectiveness of data loss prevention testing in accordance with certain embodiments of the disclosed technology.

FIG. 2 is a flow diagram illustrating an exemplary method for determining effectiveness of data loss prevention testing in accordance with certain embodiments of the disclosed technology.

FIG. 3 is a block diagram of an example DLP effectiveness evaluation system used to provide effectiveness of data loss prevention testing, according to an example implementation of the disclosed technology.

FIG. 4 is a block diagram of an example system that may be used to provide effectiveness of data loss prevention testing, according to an example implementation of the disclosed technology.

FIG. 5 is a graph of an example DLP effectiveness results based on enforcement effectiveness measures and detection effectiveness measures.

FIG. 6 is a graph of an example residual risk results based on data element type-channel effectiveness measures and inherent risk measures.

### DETAILED DESCRIPTION

Examples of the present disclosure related to systems and methods for determining effectiveness of data loss prevention testing. More particularly, the disclosed technology relates to the testing of data exfiltration prevention software (DLP) programs. The systems and methods described herein utilize, in some instances, graphical user interfaces, which are necessarily rooted in computers and technology. Graphical user interfaces (GUI) are a computer technology that allows for user interaction with computers through touch, pointing devices, or other means. The present disclosure details using a GUI to interact with a user device to test data element types through test channels. This, in some examples, may involve dynamically changing the graphical user interface so that a user's DLP program can be dynamically tested, which involves allowing the selection of customized data types and testing channels for testing. Using a graphical user interface in this way may allow the system to dynamically test data exfiltration prevention software programs in a customized manner. This is a clear advantage and improvement over prior technologies that conduct testing of DLP programs in a rigid, predictable manner because DLP programs can be programmed to pass predictable tests. The present disclosure solves this problem by dynamically changing test data through diverse test channels to accurately determine with a unique scoring scale the effectiveness of a DLP program. Overall, the systems and methods disclosed have significant practical applications in the field because of the noteworthy improvements of determining an effectiveness of data loss prevention programs, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

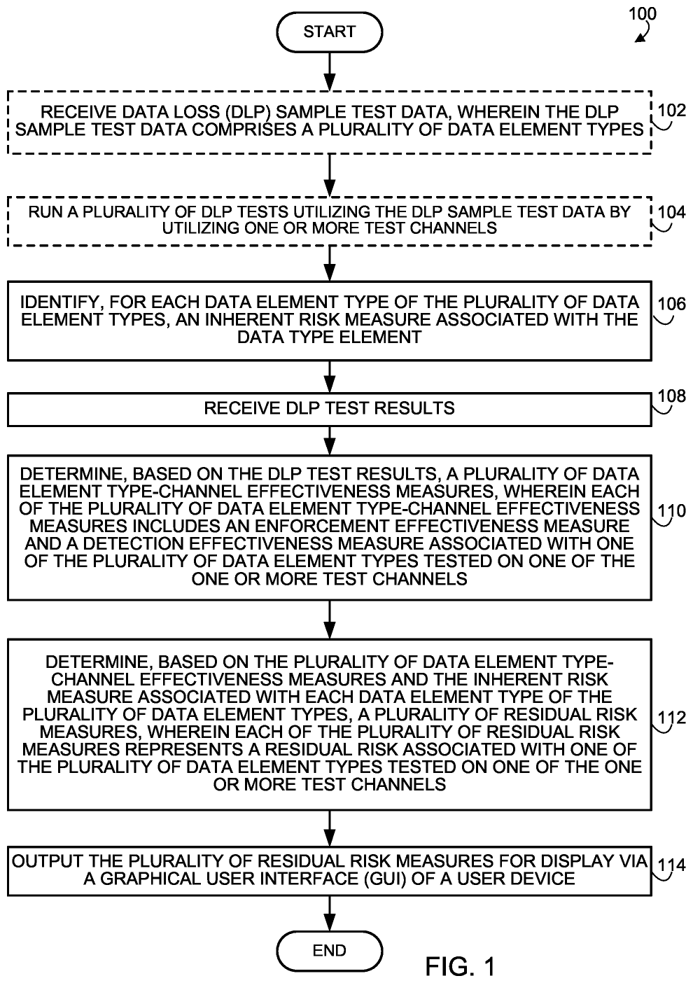

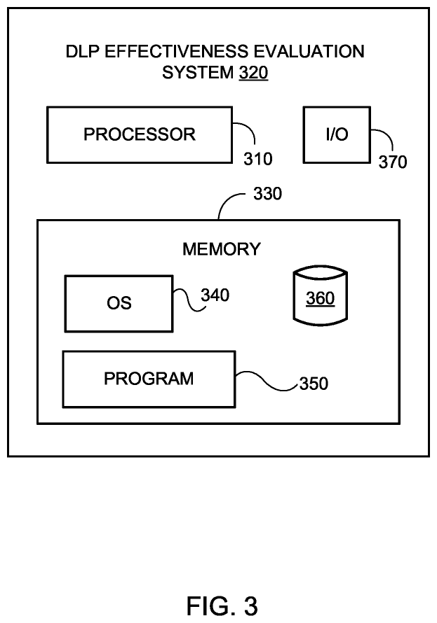

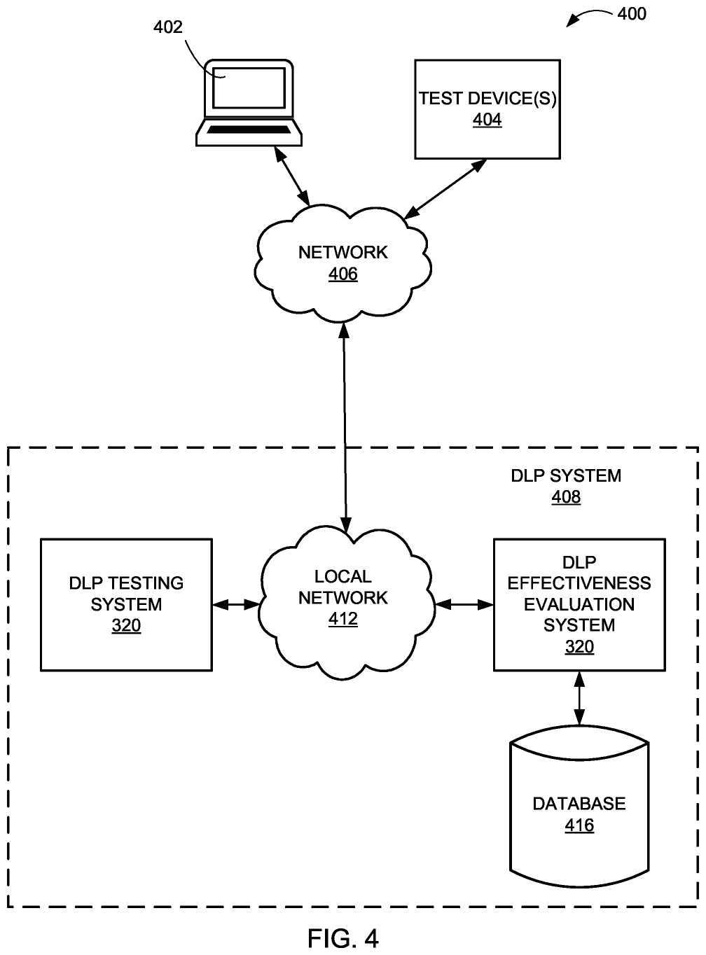

FIG. 1 is a flow diagram illustrating an exemplary method 100 for determining effectiveness of data loss prevention testing, in accordance with certain embodiments of the disclosed technology. The steps of method 100 may be performed by one or more components of the system 400 (e.g., DLP effectiveness evaluation system 320 or web server 410 of DLP system 408 or user device 402), as described in more detail with respect to FIGS. 3 and 4.

In optional block 102, the DLP effectiveness evaluation system 320 may receive data loss (DLP) sample test data. The DLP sample test data can include a plurality of data element types. The plurality of data element types can include a social security number, a primary account number, a national insurance number, a social insurance number, a bank account number, a tax identification number, an employer identification number, a driver's license number, a passport number, a unique identification number, or other private data elements known in the art. In some embodiments, the DLP effectiveness evaluation system 320 may receive DLP sample test data from a system that generates dynamic test data. The DLP effectiveness evaluation system 320 may also retrieve stored DLP sample test data as well.

In optional block 104, the DLP effectiveness evaluation system 320 may run a plurality of DLP tests utilizing the DLP sample test data by utilizing one or more test channels. The one or more test channels can include one or more of: an email channel, a network channel, an endpoint channel, a web channel, a cloud channel, or other data channels known in the art. The DLP effectiveness evaluation system 320 may utilize the DLP sample test data to conduct the plurality of DLP tests by: executing one or more transfers of at least a portion of the DLP sample test data via the one or more test channels (executing either automatically or by the DLP effectiveness evaluation system 320 or a DLP testing system 322); and monitoring, utilizing DLP programs, the one or more test channels to attempt to detect sample data of the plurality of data element types. When the one or more test channels include the email channel, the DLP effectiveness evaluation system 320 may connect to an application programming interface (API) to execute the one or more transfers of at least a portion of the DLP sample test data. When the one or more test channels include the network channel (i.e., a website), the DLP effectiveness evaluation system 320 may simulate the one or more transfers of at least a portion of the DLP sample test data through the website (i.e., simulate a malicious actor inputting a social security number through a form of a website). When the one or more test channels include the endpoint channel (i.e., such as a user device 402), the DLP effectiveness evaluation system 320 may simulate the one or more transfers of at least a portion of the DLP sample test data to a designated device or a virtual machine (i.e., stage transferring the DLP sample test data to a laptop (i.e., such as a user device 402) by sending it to the virtual machine or designated device). When the one or more test channels include the cloud channel (i.e., such as an Amazon Web Service or AWS or a similar cloud infrastructure), the DLP effectiveness evaluation system 320 may execute the one or more transfers to a S3 bucket with at least a portion of the DLP sample test data. The DLP effectiveness evaluation system 320 may then scan the S3 bucket using an S3 tool. In some embodiments, the DLP effectiveness evaluation system 320 may generate a log using the S3 tool that can be analyzed. If the one or more test channels include the cloud channel as a google drive or similar cloud infrastructure, an API can be used to transfer the at least the portion of the DLP sample test data to the google drive. Then, the DLP effectiveness evaluation system 320 may then scan the google drive. In some embodiments, the DLP effectiveness evaluation system 320 may generate a log using data from the scan of the google drive to be analyzed.

In block 106, the DLP effectiveness evaluation system 320 may identify, for each data element type of the plurality of data element types, an inherent risk measure associated with the data element type. In some examples, the inherent risk measure may be on a scale of: critical, high, medium, low, negligible, combinations thereof, or other scales known in the art. In some embodiments, a machine learning model can be trained using training sets of data element types to assign one of the inherent risk measures to each data element type by using the training sets. The training sets can include sample mappings between data element types and inherent risk measures. In other embodiments, the DLP effectiveness evaluation system 320 may use a lookup table or mapping between the data element types and the inherent risk measures to assign one of the inherent risk measures to each data element type of the plurality of data element types.

In block 108, the DLP effectiveness evaluation system 320 may receive DLP test results. The DLP effectiveness evaluation system 320 may receive DLP test results as a result of running the plurality of DLP tests utilizing the DLP sample test data. The DLP test results can include a portion of the DLP sample test data that was detected or stopped due to an enforcement action by one of the DLP programs. The DLP test results can include a second portion of the DLP sample test data that was not detected or stopped by one of the DLP programs. The DLP test results can also include a comparison of the portion of the DLP sample test data that was detected or stopped against the one or more transfers from the DLP sample test data. In a non-limiting example, the DLP sample test data can include emails with social security numbers, and the DLP effectiveness evaluation system 320 may transfer at least a portion of the emails via a selected email channel of the one or more test channels. The user may already have previously purchased DLP programs. The DLP effectiveness evaluation system 320 may then be able to compare the transferred portion of the emails to detected (or blocked) emails from the DLP programs. In this non-limiting example, the DLP test results could include the transferred portion of the emails, the detected or blocked emails from the DLP program, or emails not detected or blocked from the DLP program.

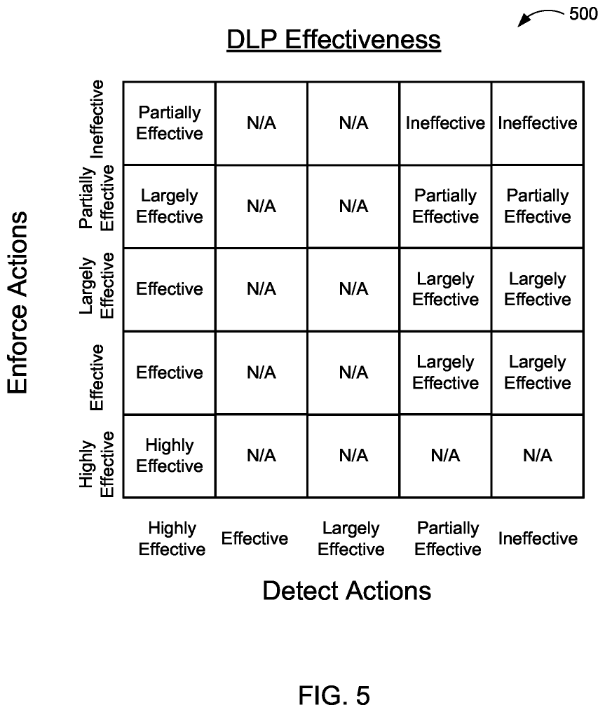

In block 110, the DLP effectiveness evaluation system 320 may determine, based on the DLP test results, a plurality of data element type-channel effectiveness measures. In some embodiments, each of the plurality of data element type-channel effectiveness measures can include an enforcement effectiveness measure and a detection effectiveness measure associated with one of the plurality of data element types tested on one of the one or more test channels as illustrated in FIG. 5. The enforcement effectiveness measure can include classifications on a first scale: highly effective, effective, largely effective, partially effective, ineffective, combinations thereof, or other scales known in the art. Each classification in the first scale can correspond to a range between zero (0) to one hundred (100) percent. For example, the ranges of: zero (0) to twenty (20) can correspond to ineffective, twenty-one (21) to forty (40) can correspond to partially effective, forty-one (41) to sixty (60) can correspond to largely effective, sixty-one (61) to eighty (80) can correspond to ineffective, and eighty-one (81) to one hundred (100) can correspond to highly effective. Non proportional ranges can also correspond to each classification in the first scale. The detection effectiveness measure can include a second scale of highly effective, effective, largely effective, partially effective, ineffective, combinations thereof, or other scales known in the art. Each classification in the second scale can correspond to a range between zero (0) to one hundred (100) percent. For example, the ranges of: zero (0) to twenty (20) can correspond to ineffective, twenty-one (21) to forty (40) can correspond to partially effective, forty-one (41) to sixty (60) can correspond to largely effective, sixty-one (61) to eighty (80) can correspond to ineffective, and eighty-one (81) to one hundred (100) can correspond to highly effective. Non proportional ranges can also correspond to each classification in the second scale.

In some embodiments, the DLP effectiveness evaluation system 320 can determine the enforcement effectiveness measure for at least one of the plurality of data element types tested on at least one of the one or more test channels by comparing the portion of the DLP sample test data that was stopped due to an enforcement action against the one or more transfers from the DLP sample test data. When the DLP effectiveness evaluation system 320 determines whether a percentage of transfers involved with the enforcement action from the DLP programs out of a total number of the one or more transfers is in one of the ranges corresponding to one of the classifications in the first scale, then the DLP effectiveness evaluation system 320 can assign the corresponding classification as the enforcement effectiveness measure. For example, using the ranges in block 110, if the percentage of transfers involved with the enforcement action from the DLP programs out of a total number of the one or more transfers is equal to fifty-nine (59) percent, then this range would correspond to the classifications in the first scale of largely effective.

In some embodiments, the DLP effectiveness evaluation system 320 can determine the detection effectiveness measure for at least one of the plurality of data element types tested on at least one of the one or more test channels by comparing the portion of the DLP sample test data that was detected by the DLP programs against the one or more transfers from the DLP sample test data. When the DLP effectiveness evaluation system 320 determines whether a second percentage of transfers detected from the DLP programs out of a total number of the one or more transfers is in one of the ranges corresponding to one of the classifications in the second scale, then the DLP effectiveness evaluation system 320 can assign the corresponding classification as the detection effectiveness measure. For example, using the ranges in block 110, if the percentage of transfers involved with the detection from the DLP programs out of a total number of the one or more transfers is equal to twenty-two (22) percent, then this range would correspond to the classifications in the second scale of partially effective.

As illustrated in FIG. 5, after the DLP effectiveness evaluation system 320 determines the enforcement effectiveness measure and the detection effectiveness measure for at least one of the plurality of data element types tested on at least one of the one or more test channels, then using a mapping between the enforcement effectiveness measure and the detection effectiveness measure, the DLP effectiveness evaluation system 320 can determine the plurality of data element type-channel effectiveness measures. Using the example lookup table in FIG. 5, and the two examples above of the largely effective classification for the enforcement effectiveness measure and the partially effective classification for the detection effectiveness measure, the DLP effectiveness evaluation system 320 can determine that the data element type-channel effectiveness measure (DLP effectiveness) is largely effective. The steps in block 110 can be repeated for each of the plurality of data element types tested on each of the one or more test channels to find the DLP effectiveness for each data element type on each test channel using each of the DLP programs.

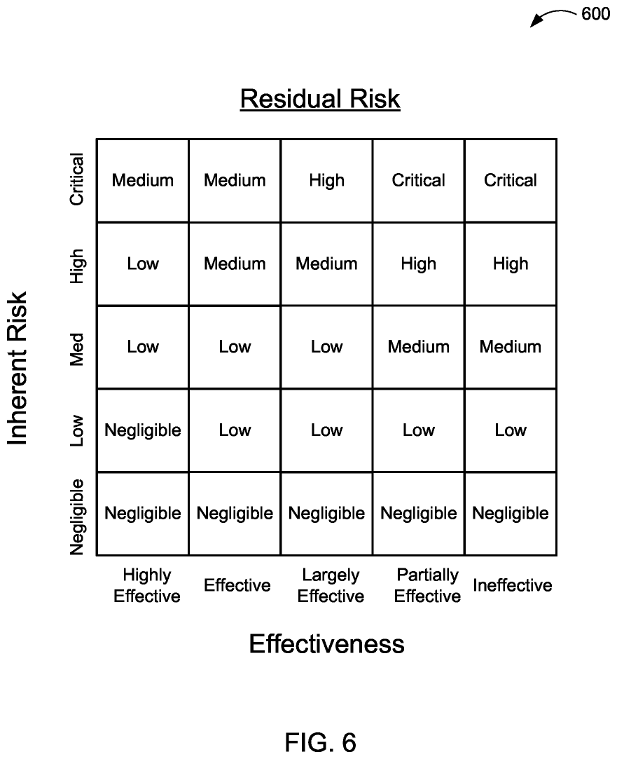

In block 112, the DLP effectiveness evaluation system 320 may determine, based on the plurality of data element type-channel effectiveness measures and the inherent risk measure associated with each data element type of the plurality of data element types, a plurality of residual risk measures as illustrated in FIG. 6. In some embodiments, each of the plurality of residual risk measures can represent a residual risk associated with one of the plurality of data element types tested on one of the one or more test channels. For example, a social security number can be assigned the inherent risk measure of high and using the example of the steps in block 110, a sample DLP program can have the DLP effectiveness of largely effective. The DLP effectiveness evaluation system 320 can determine the residual risk measure associated with the social security number (data element types) on an email channel can have the residual risk of medium. Similar steps can be used to determine the residual risk measure of each data element type on each test channel using each of the DLP programs.

In block 114, the DLP effectiveness evaluation system 320 may output the plurality of residual risk measures for display via a graphical user interface (GUI) of a user device. The DLP effectiveness evaluation system 320 may generate the GUI comprising the plurality of residual risk measures, inherent risk measures, the detection effectiveness measures, the enforcement effectiveness measure, the plurality of data element types tested, the one or more test channels, or combinations thereof. The DLP effectiveness evaluation system 320 may then transmit the GUI to the user device 402. The DLP effectiveness evaluation system 320 may, in response to the transmission, receive an indication of a selected data element type and a selected test channel as outlined below in method 200, block 202 and modify the GUI to comprise the residual risk measure corresponding to the selected data element type and the selected test channel.

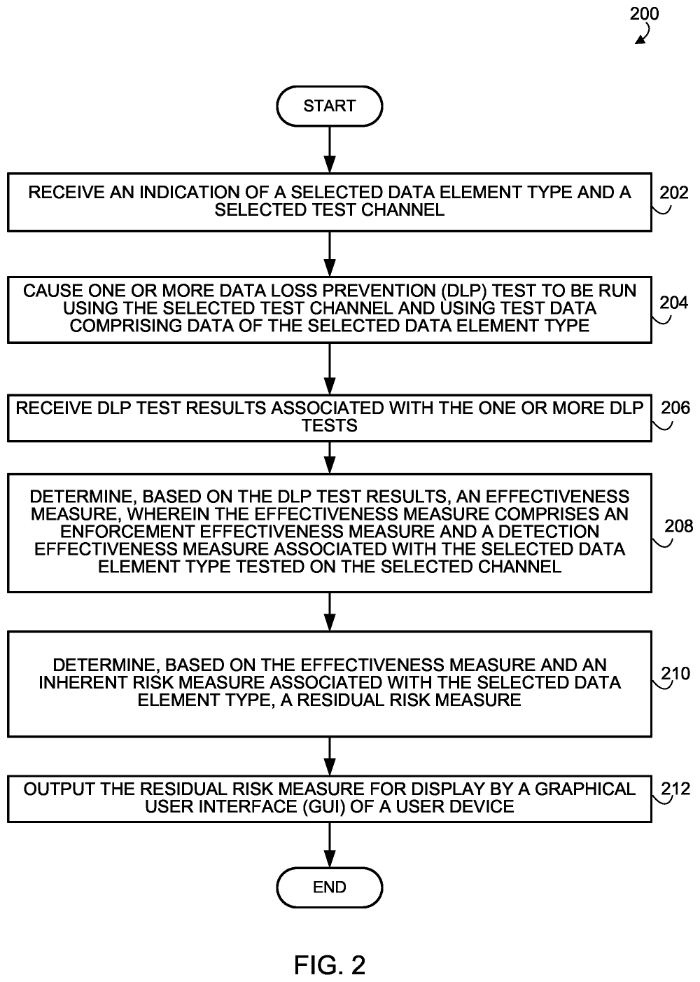

FIG. 2 is a flow diagram illustrating an exemplary method 200 for determining effectiveness of data loss prevention testing, in accordance with certain embodiments of the disclosed technology. The steps of method 200 may be performed by one or more components of the system 400 (e.g., DLP effectiveness evaluation system 320 or web server 410 of DLP system 408 or user device 402), as described in more detail with respect to FIGS. 3 and 4.

Method 200 of FIG. 2 is similar to method 100 of FIG. 1. The descriptions of blocks 206, 208, 210, and 212 in method 200 are similar to the respective descriptions of blocks 108, 110, 106 and 112, and 114 of method 100 and are not repeated herein for brevity. However, blocks 202 and 204 are different from blocks 102 and 104 and are described below.

In block 202, the DLP effectiveness evaluation system 320 may receive the indication of the selected data element type and the selected test channel. The selected data element type can be one of the plurality of data element types and the selected test channel can be one of the one or more test channels outlined in optional block 102 of method 100. The DLP effectiveness evaluation system 320 may receive the indication from the user device 402.

In block 204, the DLP effectiveness evaluation system 320 may cause one or more data loss prevention (DLP) tests to be run as outlined in method 100, optional block 104. In some embodiments, the DLP effectiveness evaluation system 320 may transmit the selected data element type to the system that generates dynamic test data. The DLP effectiveness evaluation system 320 may receive the test data including data of the selected data element type from the system that generates dynamic test data as outlined in method 100, optional block 102. The DLP effectiveness evaluation system 320 may also retrieve the test data stored in memory.

FIG. 3 is a block diagram of an example DLP effectiveness evaluation system 320 used to test DLP programs according to an example implementation of the disclosed technology. According to some embodiments, the user device 402 and web server 410, as depicted in FIG. 4 and described below, may have a similar structure and components that are similar to those described with respect to DLP effectiveness evaluation system 320 shown in FIG. 3. As shown, the DLP effectiveness evaluation system 320 may include a processor 310, an input/output (I/O) device 370, a memory 330 containing an operating system (OS) 340 and a program 350. In certain example implementations, the DLP effectiveness evaluation system 320 may be a single server or may be configured as a distributed computer system including multiple servers or computers that interoperate to perform one or more of the processes and functionalities associated with the disclosed embodiments. In some embodiments DLP effectiveness evaluation system 320 may be one or more servers from a serverless or scaling server system. In some embodiments, the DLP effectiveness evaluation system 320 may further include a peripheral interface, a transceiver, a mobile network interface in communication with the processor 310, a bus configured to facilitate communication between the various components of the DLP effectiveness evaluation system 320, and a power source configured to power one or more components of the DLP effectiveness evaluation system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the DLP effectiveness evaluation system 320 may include one or more storage devices configured to store information used by the processor 310 (or other components) to perform certain functions related to the disclosed embodiments. In one example, the DLP effectiveness evaluation system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The DLP effectiveness evaluation system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the DLP effectiveness evaluation system 320 may include the memory 330 that may include one or more programs 350 to perform one or more functions of the disclosed embodiments. For example, in some embodiments, the DLP effectiveness evaluation system 320 may additionally manage dialogue and/or other interactions with the customer via a program 350.

The processor 310 may execute one or more programs 350 located remotely from the DLP effectiveness evaluation system 320. For example, the DLP effectiveness evaluation system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a DLP effectiveness evaluation system database 360 for storing related data to enable the DLP effectiveness evaluation system 320 to perform one or more of the processes and functionalities associated with the disclosed embodiments.

The DLP effectiveness evaluation system database 360 may include stored data relating to status data (e.g., average session duration data, location data, idle time between sessions, and/or average idle time between sessions) and historical status data. According to some embodiments, the functions provided by the DLP effectiveness evaluation system database 360 may also be provided by a database that is external to the DLP effectiveness evaluation system 320, such as the database 416 as shown in FIG. 4.

The DLP effectiveness evaluation system 320 may also be communicatively connected to one or more memory devices (e.g., databases) locally or through a network. The remote memory devices may be configured to store information and may be accessed and/or managed by the DLP effectiveness evaluation system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The DLP effectiveness evaluation system 320 may also include one or more I/O devices 370 that may include one or more interfaces for receiving signals or input from devices and providing signals or output to one or more devices that allow data to be received and/or transmitted by the DLP effectiveness evaluation system 320. For example, the DLP effectiveness evaluation system 320 may include interface components, which may provide interfaces to one or more input devices, such as one or more keyboards, mouse devices, touch screens, track pads, trackballs, scroll wheels, digital cameras, microphones, sensors, and the like, that enable the DLP effectiveness evaluation system 320 to receive data from a user (such as, for example, via the user device 402).

In examples of the disclosed technology, the DLP effectiveness evaluation system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The DLP effectiveness evaluation system 320 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The DLP effectiveness evaluation system 320 may be configured to adjust model parameters during training. Model parameters may include weights, coefficients, offsets, or the like. Training may be supervised or unsupervised.

The DLP effectiveness evaluation system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The DLP effectiveness evaluation system 320 may be configured to optimize statistical models using known optimization techniques.

Furthermore, the DLP effectiveness evaluation system 320 may include programs configured to retrieve, store, and/or analyze properties of data models and datasets. For example, DLP effectiveness evaluation system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The DLP effectiveness evaluation system 320 may include algorithms to determine a data type, key-value pairs, row-column data structure, statistical distributions of information such as keys or values, or other property of a data schema may be configured to return a statistical profile of a dataset (e.g., using a data-profiling model). The DLP effectiveness evaluation system 320 may be configured to implement univariate and multivariate statistical methods. The DLP effectiveness evaluation system 320 may include a regression model, a Bayesian model, a statistical model, a linear discriminant analysis model, or other classification model configured to determine one or more descriptive metrics of a dataset. For example, DLP effectiveness evaluation system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The DLP effectiveness evaluation system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, DLP effectiveness evaluation system 320 may be configured to generate a similarity metric representing a measure of similarity between data in a dataset. A similarity metric may be based on a correlation, covariance matrix, a variance, a frequency of overlapping values, or other measure of statistical similarity.

The DLP effectiveness evaluation system 320 may be configured to generate a similarity metric based on data model output, including data model output representing a property of the data model. For example, DLP effectiveness evaluation system 320 may be configured to generate a similarity metric based on activation function values, embedding layer structure and/or outputs, convolution results, entropy, loss functions, model training data, or other data model output). For example, a synthetic data model may produce first data model output based on a first dataset and a produced data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The DLP effectiveness evaluation system 320 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The DLP effectiveness evaluation system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, DLP effectiveness evaluation system 320 is configured to generate and/or train a classification model to classify a dataset, consistent with disclosed embodiments.

The DLP effectiveness evaluation system 320 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via one or more weighted connections. Prediction models may additionally or alternatively include classification and regression trees, or other types of models known to those skilled in the art. To generate prediction models, the DLP effectiveness evaluation system may analyze information applying machine-learning methods.

While the DLP effectiveness evaluation system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the DLP effectiveness evaluation system 320 may include a greater or lesser number of components than those illustrated.

FIG. 4 is a block diagram of an example system that may be DLP system 408, according to an example implementation of the disclosed technology. The components and arrangements shown in FIG. 4 are not intended to limit the disclosed embodiments as the components used to implement the disclosed processes and features may vary. As shown, DLP system 408 may interact with a user device 402 via a network 406. In certain example implementations, the DLP system 408 may include a local network 412, a DLP effectiveness evaluation system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the DLP system 408. In some embodiments, the user device 402 may include or incorporate electronic communication devices for hearing or vision impaired users.

According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The DLP system 408 may be associated with and optionally controlled by one or more entities such as a business, corporation, individual, partnership, or any other entity that provides one or more of goods, services, and consultations to individuals such as customers. In some embodiments, the DLP system 408 may be controlled by a third party on behalf of another business, corporation, individual, partnership, etc. The DLP system 408 may include one or more servers and computer systems for performing one or more functions associated with products and/or services that the organization provides.

Web server 410 may include a computer system configured to generate and provide one or more websites accessible to customers, as well as any other individuals involved in access system 408′s normal operations. Web server 410 may include a computer system configured to receive communications from user device 402 via, for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that is authenticated by the DLP effectiveness evaluation system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the DLP system 408 to interact with one another and to connect to the network 406 for interacting with components in the system 400 environment. In some embodiments, the local network 412 may include an interface for communicating with or linking to the network 406. In other embodiments, certain components of the DLP system 408 may communicate via the network 406, without a separate local network 406.

The DLP system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access DLP system 408 using the cloud computing environment. User device 402 may be able to access DLP system 408 using specialized software. The cloud computing environment may eliminate the need to install specialized software on user device 402.

In accordance with certain example implementations of the disclosed technology, the DLP system 408 may include one or more computer systems configured to compile data from a plurality of sources the DLP effectiveness evaluation system 320, web server 410, and/or the database 416. The DLP effectiveness evaluation system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

### EXAMPLE USE CASE

The following example use case describes an example of a typical user flow pattern. This section is intended solely for explanatory purposes and not in limitation.

In one example, a customer John has a data loss prevention program for a user device 402. John is trying to determine if he should get a different data loss prevention program or continue using the current data loss prevention program on his user device 402. The data loss prevention program advertises that malicious actors attempting to retrieve sensitive information such as social security numbers will be detected and stopped. To test the data loss prevention program, John may use the DLP effectiveness evaluation system 320 to receive or retrieve a DLP sample test data. In some embodiments, the DLP effectiveness evaluation system 320 may run a plurality of DLP tests utilizing the DLP sample test data of social security numbers by utilizing one or more test channels such as email channels like Outlook. The DLP effectiveness evaluation system 320 may then identify, for each data element type of the plurality of data element types, an inherent risk measure associated with the data element type. In this example, an inherent risk measure of high may be identified for social security numbers. A plurality of emails may be sent by the DLP effectiveness evaluation system 320 to an email address used by the user device 402. The DLP effectiveness evaluation system 320 may then receive DLP test results that show that the data loss prevention program stopped 45 emails containing social security numbers from being sent and detected 32 emails that were sent that contained social security numbers. The DLP test results may also show that the DLP effectiveness evaluation system 320 sends 100 emails containing social security numbers. The DLP effectiveness evaluation system 320 may determine, based on the DLP test results, a plurality of data element type-channel effectiveness measures by determining an enforcement effectiveness measure and a detection effectiveness measure associated with one of the plurality of data element types tested on one of the one or more test channels. The DLP effectiveness evaluation system 320 may determine that the enforcement effectiveness measure is largely effective considering that 45% of the emails with social security numbers were stopped (assuming the ranges in the first scale of method 100, block 110 are used). The DLP effectiveness evaluation system 320 may determine that the detection effectiveness measure is partially effective considering that 32% of the emails with social security numbers were stopped (assuming the ranges in the second scale of method 100, block 110 are used). In some embodiments, the DLP effectiveness evaluation system 320 may determine, using the FIG. 5 lookup table, and based on the enforcement effectiveness measure of largely effective and the detection effectiveness measure of partially effective, that the plurality of data element type-channel effectiveness measure is largely effective. The DLP effectiveness evaluation system 320 may then determine, considering the plurality of data element type-channel effectiveness measure is largely effective and the inherent risk measure is high, that the residual risk measure is medium (according to the mapping in FIG. 6). The DLP effectiveness evaluation system 320 may then generate a graphical user interface comprising of the residual risk measure to let John know that the DLP program has a medium residual risk. The DLP effectiveness evaluation system 320 may then transmit the graphical user interface to the user device 402.

In some examples, disclosed systems or methods may involve one or more of the following clauses:

Clause 1: A system comprising: one or more processors; and a memory in communication with the one or more processors and storing instructions that, when executed by the one or more processors, are configured to cause the system to: receive data loss prevention (DLP) sample test data, wherein the DLP sample test data comprises a plurality of data element types; run a plurality of DLP tests utilizing the DLP sample test data by utilizing one or more test channels; identify, for each data element type of the plurality of data element types, an inherent risk measure associated with the data type element; receive DLP test results; determine, based on the DLP test results, a plurality of data element type-channel effectiveness measures, wherein each of the plurality of data element type-channel effectiveness measures comprises an enforcement effectiveness measure and a detection effectiveness measure associated with one of the plurality of data element types tested on one of the one or more test channels; determine, based on the plurality of data element type-channel effectiveness measures and the inherent risk measure associated with each data element type of the plurality of data element types, a plurality of residual risk measures, wherein each of the plurality of residual risk measures represents a residual risk associated with one of the plurality of data element types tested on one of the one or more test channels; and output the plurality of residual risk measures for display via a graphical user interface (GUI) of a user device.

Clause 2: The system of claim 1, wherein the plurality of DLP tests is intermittently automatically run and the instructions are further configured to cause the system to: iteratively update the plurality of residual risk measures output for display via the GUI of the user device based on new DLP test results.

Clause 3: The system of claim 1, wherein running the plurality of DLP tests comprises: transferring data of each data element type of the plurality of data element types using each test channel of the one or more test channels.

Clause 4: The system of claim 3, wherein the one or more test channels comprise one or more of: an email channel; a cloud channel; a web channel; a network channel; and an endpoint channel.

Clause 5: The system of claim 1, wherein the DLP test results comprise logs generated by one or more DLP programs configured to monitor the one or more test channels for the plurality of data element types.

Clause 6: The system of claim 5, wherein enforcement effectiveness measures represent the one or more DLP program's effectiveness at executing enforcement actions in association with a particular data element type in a particular test channel and detection effectiveness measures represent the one or more DLP program's effectiveness at detecting the particular data element type in the particular test channel.

Clause 7: The system of claim 1, wherein determining the plurality of residual risk measures comprises, for each of the plurality of data element type-channel effectiveness measures: determining, based on the enforcement effectiveness measure and the detection effectiveness measure, an overall effectiveness measure; and determining a difference between the overall effectiveness measure and the inherent risk measure associated with the data element type associated with the data element type-channel effectiveness measure.

Clause 8: The system of claim 1, wherein the plurality of DLP tests is automatically run on a daily basis.

Clause 9: The system of claim 8, wherein the instructions are further configured to cause the system to: determine a first plurality of residual risk measures on a first day; determine a second plurality of residual risk measures on a second day; and responsive to determining that one or more residual risk measures have increased beyond a predetermined threshold based on a comparison of the first plurality of residual risk measures and the second plurality of residual risk measures, automatically reverting one or more DLP policies to a version that existed on the first day.

Clause 10: A system comprising: one or more processors; and a memory in communication with the one or more processors and storing instructions that, when executed by the one or more processors, are configured to cause the system to: identify, for each data element type of a plurality of data element types, an inherent risk measure associated with the data type element; receive data loss prevention (DLP) test results; determine, based on the DLP test results, a plurality of data element type-channel effectiveness measures, wherein each of the plurality of data element type-channel effectiveness measures comprises an enforcement effectiveness measure and a detection effectiveness measure associated with one of the plurality of data element types tested on one of one or more test channels; determine, based on the plurality of data element type-channel effectiveness measures and the inherent risk measure associated with each data element type of the plurality of data element types, a plurality of residual risk measures, wherein each of the plurality of residual risk measures represents a residual risk associated with one of the plurality of data element types tested on one of the one or more test channels; and output the plurality of residual risk measures for display via a graphical user interface (GUI) of a user device.

Clause 11: The system of claim 10, wherein the one or more test channels comprise one or more of: an email channel; a cloud channel; a web channel; a network channel; and an endpoint channel.

Clause 12: The system of claim 10, wherein the DLP test results comprise logs generated by one or more DLP programs configured to monitor the one or more test channels for the plurality of data element types.

Clause 13: The system of claim 10, wherein determining the plurality of residual risk measures comprises, for each of the plurality of data element type-channel effectiveness measures: determining, based on the enforcement effectiveness measure and the detection effectiveness measure, an overall effectiveness measure; and determining a difference between the overall effectiveness measure and the inherent risk measure associated with the data element type associated with the data element type-channel effectiveness measure.

Clause 14: The system of claim 10, wherein the instructions are further configured to cause the system to: determine a first plurality of residual risk measures on a first day; determine a second plurality of residual risk measures on a second day; and responsive to determining that one or more residual risk measures have increased beyond a predetermined threshold based on a comparison of the first plurality of residual risk measures and the second plurality of residual risk measures, automatically reverting one or more DLP policies to a version that existed on the first day.

Clause 15: A system comprising: one or more processors; and a memory in communication with the one or more processors and storing instructions that, when executed by the one or more processors, are configured to cause the system to: receive an indication of a selected data element type and a selected test channel; cause one or more data loss prevention (DLP) tests to be run using the selected test channel and using test data comprising data of the selected data element type; receive DLP test results associated with the one or more DLP tests; determine, based on the DLP test results, an effectiveness measure, wherein the effectiveness measure comprises an enforcement effectiveness measure and a detection effectiveness measure associated with the selected data element type tested on the selected test channel; determine, based on the effectiveness measure and an inherent risk measure associated with the selected data element type, a residual risk measure; and output the residual risk measure for display by a graphical user interface (GUI) of a user device.

Clause 16: The system of claim 15, wherein the selected test channel comprises one of: an email channel; a cloud channel; a web channel; a network channel; and an endpoint channel.

Clause 17: The system of claim 15, wherein the DLP test results comprise logs generated by one or more DLP programs configured to monitor the selected test channel for the selected data element type.

Clause 18: The system of claim 17, wherein the enforcement effectiveness measure represents the one or more DLP program's effectiveness at executing enforcement actions in association with the selected data element type in the selected test channel and the detection effectiveness measure represents the one or more DLP program's effectiveness at detecting the selected data element type in the selected test channel.

Clause 19: The system of claim 15, wherein determining the residual risk measure comprises: determining, based on the enforcement effectiveness measure and the detection effectiveness measure, an overall effectiveness measure; and determining a difference between the overall effectiveness measure and the inherent risk measure.

Clause 20: The system of claim 15, wherein the instructions are further configured to cause the system to: responsive to determining that the residual risk measure is higher than a previously determined residual risk measure associated with the selected data element type beyond a predetermined threshold, output an indication of a previous version of a DLP program that was deployed when the previously determined residual risk measure was determined for display via the GUI of the user device; and responsive to receiving an instruction from the user device, cause a current version of a deployed DLP program to be replaced with the previous version of the DLP program.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors; and
a memory in communication with the one or more processors and storing instructions that, when executed by the one or more processors, are configured to cause the system to:
receive data loss prevention (DLP) sample test data, wherein the DLP sample test data comprises a plurality of data element types;
run a plurality of DLP tests utilizing the DLP sample test data by utilizing one or more test channels;
identify, for each data element type of the plurality of data element types, an inherent risk measure associated with the data type element;
receive DLP test results;
determine, based on the DLP test results, a plurality of data element type-channel effectiveness measures, wherein each of the plurality of data element type-channel effectiveness measures comprises an enforcement effectiveness measure and a detection effectiveness measure associated with one of the plurality of data element types tested on one of the one or more test channels;
determine, based on the plurality of data element type-channel effectiveness measures and the inherent risk measure associated with each data element type of the plurality of data element types, a plurality of residual risk measures, wherein each of the plurality of residual risk measures represents a residual risk associated with one of the plurality of data element types tested on one of the one or more test channels; and
output the plurality of residual risk measures for display via a graphical user interface (GUI) of a user device.

2. The system of claim 1, wherein the plurality of DLP tests is intermittently automatically run and the instructions are further configured to cause the system to:
iteratively update the plurality of residual risk measures output for display via the GUI of the user device based on new DLP test results.

3. The system of claim 1, wherein running the plurality of DLP tests comprises:
transferring data of each data element type of the plurality of data element types using each test channel of the one or more test channels.

4. The system of claim 3, wherein the one or more test channels comprise one or more of:
an email channel;
a cloud channel;
a web channel;
a network channel; and
an endpoint channel.

5. The system of claim 1, wherein the DLP test results comprise logs generated by one or more DLP programs configured to monitor the one or more test channels for the plurality of data element types.

6. The system of claim 5, wherein enforcement effectiveness measures represent the one or more DLP program's effectiveness at executing enforcement actions in association with a particular data element type in a particular test channel and detection effectiveness measures represent the one or more DLP program's effectiveness at detecting the particular data element type in the particular test channel.

7. The system of claim 1, wherein determining the plurality of residual risk measures comprises, for each of the plurality of data element type-channel effectiveness measures:
determining, based on the enforcement effectiveness measure and the detection effectiveness measure, an overall effectiveness measure; and
determining a difference between the overall effectiveness measure and the inherent risk measure associated with the data element type associated with the data element type-channel effectiveness measure.

8. The system of claim 1, wherein the plurality of DLP tests is automatically run on a daily basis.

9. The system of claim 8, wherein the instructions are further configured to cause the system to:
determine a first plurality of residual risk measures on a first day;
determine a second plurality of residual risk measures on a second day; and
responsive to determining that one or more residual risk measures have increased beyond a predetermined threshold based on a comparison of the first plurality of residual risk measures and the second plurality of residual risk measures, automatically reverting one or more DLP policies to a version that existed on the first day.

10. A system comprising:
one or more processors; and
a memory in communication with the one or more processors and storing instructions that, when executed by the one or more processors, are configured to cause the system to:
identify, for each data element type of a plurality of data element types, an inherent risk measure associated with the data type element;
receive data loss prevention (DLP) test results;
determine, based on the DLP test results, a plurality of data element type-channel effectiveness measures, wherein each of the plurality of data element type-channel effectiveness measures comprises an enforcement effectiveness measure and a detection effectiveness measure associated with one of the plurality of data element types tested on one of one or more test channels;
determine, based on the plurality of data element type-channel effectiveness measures and the inherent risk measure associated with each data element type of the plurality of data element types, a plurality of residual risk measures, wherein each of the plurality of residual risk measures represents a residual risk associated with one of the plurality of data element types tested on one of the one or more test channels; and
output the plurality of residual risk measures for display via a graphical user interface (GUI) of a user device.

11. The system of claim 10, wherein the one or more test channels comprise one or more of:
an email channel;
a cloud channel;
a web channel;
a network channel; and
an endpoint channel.

12. The system of claim 10, wherein the DLP test results comprise logs generated by one or more DLP programs configured to monitor the one or more test channels for the plurality of data element types.

13. The system of claim 10, wherein determining the plurality of residual risk measures comprises, for each of the plurality of data element type-channel effectiveness measures:
determining, based on the enforcement effectiveness measure and the detection effectiveness measure, an overall effectiveness measure; and
determining a difference between the overall effectiveness measure and the inherent risk measure associated with the data element type associated with the data element type-channel effectiveness measure.

14. The system of claim 10, wherein the instructions are further configured to cause the system to:
determine a first plurality of residual risk measures on a first day;
determine a second plurality of residual risk measures on a second day; and
responsive to determining that one or more residual risk measures have increased beyond a predetermined threshold based on a comparison of the first plurality of residual risk measures and the second plurality of residual risk measures, automatically reverting one or more DLP policies to a version that existed on the first day.

15. A system comprising:
one or more processors; and
a memory in communication with the one or more processors and storing instructions that, when executed by the one or more processors, are configured to cause the system to:
receive an indication of a selected data element type and a selected test channel;
cause one or more data loss prevention (DLP) tests to be run using the selected test channel and using test data comprising data of the selected data element type;
receive DLP test results associated with the one or more DLP tests;
determine, based on the DLP test results, an effectiveness measure, wherein the effectiveness measure comprises an enforcement effectiveness measure and a detection effectiveness measure associated with the selected data element type tested on the selected test channel;
determine, based on the effectiveness measure and an inherent risk measure associated with the selected data element type, a residual risk measure; and
output the residual risk measure for display by a graphical user interface (GUI) of a user device.

16. The system of claim 15, wherein the selected test channel comprises one of:
an email channel;
a cloud channel;
a web channel;
a network channel; and
an endpoint channel.

17. The system of claim 15, wherein the DLP test results comprise logs generated by one or more DLP programs configured to monitor the selected test channel for the selected data element type.

18. The system of claim 17, wherein the enforcement effectiveness measure represents the one or more DLP program's effectiveness at executing enforcement actions in association with the selected data element type in the selected test channel and the detection effectiveness measure represents the one or more DLP program's effectiveness at detecting the selected data element type in the selected test channel.

19. The system of claim 15, wherein determining the residual risk measure comprises:
determining, based on the enforcement effectiveness measure and the detection effectiveness measure, an overall effectiveness measure; and
determining a difference between the overall effectiveness measure and the inherent risk measure.

20. The system of claim 15, wherein the instructions are further configured to cause the system to:
responsive to determining that the residual risk measure is higher than a previously determined residual risk measure associated with the selected data element type beyond a predetermined threshold, output an indication of a previous version of a DLP program that was deployed when the previously determined residual risk measure was determined for display via the GUI of the user device; and
responsive to receiving an instruction from the user device, cause a current version of a deployed DLP program to be replaced with the previous version of the DLP program.
